(19) United States
(12) Patent Application Publication
(10) Pub. No.: US 2024/0427684 A1
(43) Pub. Date: Dec. 26, 2024

(54) ABNORMAL POINT SIMULATION

(71) Applicant: International Business Machines Corporation, Armonk, NY (US)

(72) Inventors: Si Er Han, Xi'an (CN); Xiao Ming Ma, Xi'an (CN); Jun Wang, Xi'an (CN); Wen Pei Yu, Xi'an (CN); Xue Ying Zhang, Xi'an (CN); Jing James Xu, Xi'an (CN); Jing Xu, Xian (CN)

(21) Appl. No.: 18/337,469

(22) Filed: Jun. 20, 2023

(51) Int. Cl. G06F 11/30

(52) U.S. Cl. CPC G06F 11/3082; G06F 11/3075

(57) ABSTRACT

A computer-implemented method, a system and a computer program product for abnormal point simulation are disclosed. A processor analyzes a plurality of data blocks in first time series data to determine traits of respective data blocks. For the respective data blocks, a processor simulates one or more abnormal points based on the traits of the respective data blocks.

### BACKGROUND

The present invention relates to data processing, and more specifically, to abnormal point simulation in time series data.

In some industry fields, such as Internet of Things (IoT) field, a system may be monitored by sensors, which may produce time series data. When the time series data changes within a normal range, the system being monitored works well. However, if an anomaly is detected in the time series data, it may indicate a problem or malfunction in the system. Machine learning models can be utilized to identify the anomaly in time. The machine learning models can be evaluated with evaluation data. An abnormal point can be simulated in the evaluation data to improve the evaluation results.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one embodiment of the present invention, there is provided a computer-implemented method for abnormal point simulation. In the method, a plurality of data blocks in first time series data are analyzed to determine traits of respective data blocks. For the respective data blocks, one or more abnormal points are simulated based on the traits of the respective data blocks.

Therefore, the time series data can be analyzed and simulated with appropriate abnormal points (for example, appropriate values, number, abnormal type, location).

In some embodiments, analyzing the plurality of data blocks in the first time series data to determine the traits of the respective data blocks may comprise: splitting the first time series data into a plurality of data blocks in sequence; determining traits of the respective data blocks; clustering the respective data blocks based on the traits of the respective data blocks; deciding whether there are adjacent data blocks belonging to a same cluster; and in response to that there are adjacent data blocks belonging to the same cluster, merging the adjacent data blocks belonging to the same cluster into a same data block and repeating the determining, clustering, and deciding steps. Therefore, various data blocks in the first time series data can be determined based on their traits for facilitating the following simulation process.

In some embodiments, analyzing the plurality of data blocks in the first time series data to determine the traits of the respective data blocks may further comprise: identifying a set of abnormal points in second time series data and a reference data block located before the set of abnormal points; acquiring a trait of the reference data block. Clustering the respective data blocks based on the traits of the respective data blocks may comprise: clustering the respective data blocks and the reference data block based on the traits of the respective data blocks and the trait of the reference data block to determine one or more target data blocks from the respective data blocks that belongs to a same cluster to the reference data block. Therefore, target data blocks in the first time series data can be determined based on traits of the second time series data for facilitating the following simulation process.

In some embodiments, identifying a set of abnormal points in second time series data may comprise: identifying an abnormal type of the set of abnormal points in the second time series data. Simulating, for the respective data blocks, the one or more abnormal points based on the traits of the respective data blocks may further comprise: simulating, in a data block after the respective target data blocks, the one or more abnormal points based on the abnormal type of the set of abnormal points in the second time series data. Therefore, an appropriate abnormal type of abnormal points can be determined.

In some embodiments, a number of abnormal points simulated in a data block after the respective target data blocks may be greater than a number of abnormal points simulated in other data blocks. Therefore, an appropriate number and location of abnormal points can be determined.

In some embodiments, the method further may comprise evaluating one or more models with the first time series data having the simulated one or more abnormal points. Therefore, the evaluation result of the one or more models can be improved.

In some embodiments, the one or more models may be built with training data. The second time series data comprises the training data and/or historical data.

In some embodiments, the traits may comprise at least one of: mean, variance, autocorrelation function, partial autocorrelation function, and trend.

In some embodiments, the abnormal type may comprise at least one of: an extreme outlier, a variance change, and a level shift.

According to another embodiment of the present invention, there is provided a system for abnormal point simulation. The system may comprise one or more processors, a memory coupled to at least one of the one or more processors, and a set of computer program instructions stored in the memory. The set of computer program instructions may be executed by at least one of one or more processors to perform the above methods.

According to another embodiment of the present invention, there is provided a computer program product for abnormal point simulation. The computer program product may comprise a computer readable storage medium having program instructions embodied therewith. The program instructions executable by one or more processors causes the one or more processors to perform the above methods.

In addition to the exemplary aspects and embodiments described above, further aspects and embodiments will become apparent by reference to the drawings and by study of the following descriptions.

### BRIEF DESCRIPTION OF THE DRAWINGS

Through the more detailed description of some embodiments of the present invention in the accompanying drawings, the above and other objects, features and advantages of the present invention will become more apparent, wherein the same reference generally refers to the same components in the embodiments of the present invention.

FIG. 1 shows an exemplary computing environment that is applicable to implement the embodiments of the present invention.

FIG. 2 shows a block diagram illustrating an exemplary system for abnormal point simulation according to embodiments of the present invention.

FIG. 3 shows a flowchart illustrating an exemplary process for time series data analysis according to embodiments of the present invention.

FIG. 4A and FIG. 4B show graphs of exemplary first time series data according to embodiments of the present invention.

FIG. 5 shows a flowchart illustrating an exemplary process for time series data analysis according to embodiments of the present invention.

FIG. 6 shows a graph of exemplary second time series data according to embodiments of the present invention.

FIG. 7A, FIG. 7B and FIG. 7C show graphs of exemplary time series data with various abnormal types of abnormal points according to embodiments of the present invention.

FIG. 8 shows a flowchart illustrating a computer-implemented method for abnormal point simulation according to embodiments of the present invention.

### DETAILED DESCRIPTION

Various aspects of the present invention are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present invention to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as abnormal point simulation system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

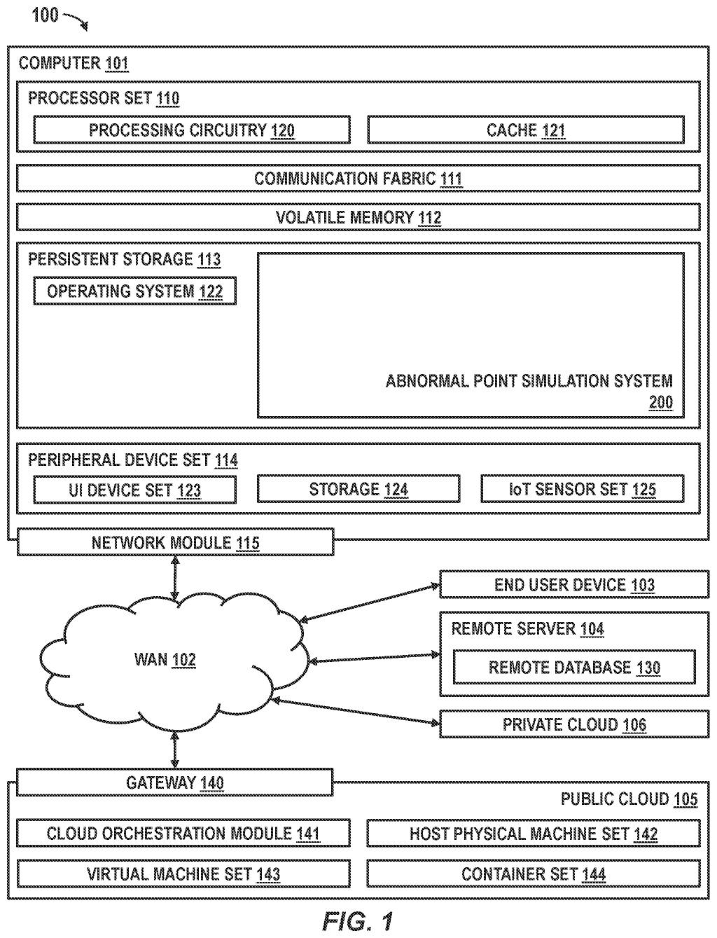

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is understood that the computing environment 100 in FIG. 1 is only provided for illustration purpose without suggesting any limitation to any embodiment of this invention, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when need. For another example, the peripheral device set 114 could also be implemented by an independent peripheral device connected to the computer 101 through interface. For a further example, the WAN may be replaced and/or supplemented by any other connection made to an external computer (for example, through the Internet using an Internet Service Provider).

Generally, a semi-supervised method can be utilized for anomaly detection. In the method, a plurality of models (e.g., machine learning models) may be built/trained on training data (e.g., time series data containing normal data) to find out normal patterns. The models may receive prediction data (e.g., time series data generated by sensors), and then predict values/points in the prediction data one by one. If any points/values do not belong to the normal patterns, the points/values can be identified as an anomaly.

The trained plurality of models may be evaluated or ranked with evaluation data (e.g., time series data containing abnormal points), in a model evaluation phase, to select an optimal model for identifying abnormal points. For improving the evaluation result, the evaluation data may be augmented by simulating some abnormal points.

Embodiments of the present invention provide a computer-implemented method, a system, and a computer program product for simulating abnormal points in time series data (e.g., the evaluation data discussed above). In the embodiments, a proper type, number, and/or location of the simulated abnormal points can be determined to improve the evaluation result.

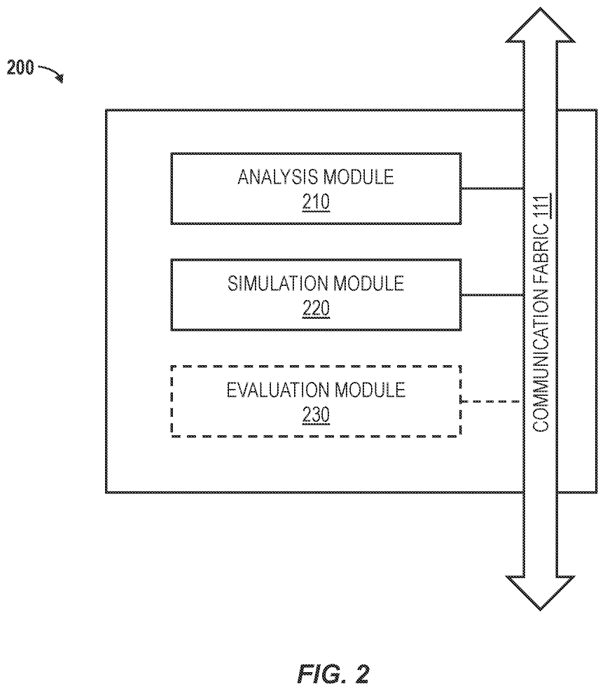

With reference now to FIG. 2, a block diagram is provided illustrating an exemplary system for abnormal point simulation in time series data, also referred to as the abnormal point simulation system 200, according to some embodiments of the present invention.

It should be noted that the processing of the abnormal point simulation system 200 according to embodiments of this invention could be implemented in the computing environment of FIG. 1.

As depicted in FIG. 2, in some embodiments, the abnormal point simulation system 200 may comprise an analysis module 210 and a simulation module 220. In further embodiments, the abnormal point simulation system 200 may also comprise an evaluation module 230. All, or some, of the modules may be configured to communicate with each other (e.g., via the communication fabric 111 as depict in FIG. 1, such as a bus, shared memory, a switch, or a network). Any one or more of these modules may be implemented using a computing device, such as the processing circuitry 120 in FIG. 1 (e.g., by configuring the processing circuitry 120 to perform functions described for that module). It can be noted that, the addition, removal and/or modification of one or more modules can be configured based on actual needs.

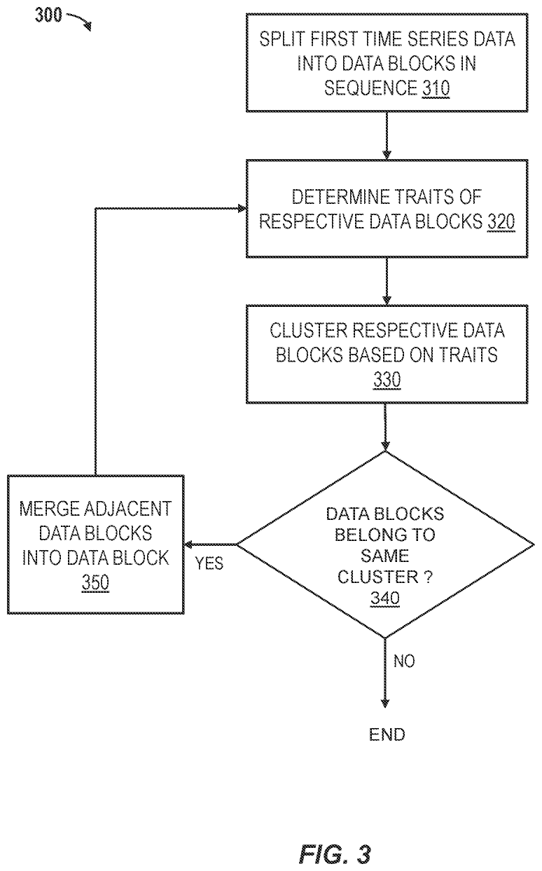

The analysis module 210 may analyze a plurality of data blocks in first time series data to determine traits of respective data blocks. The first time series data may be a sequence of data points in time order, such that the traits can be obtained based on values of data points in the sequence. In some embodiments, the first time series data may be configured to evaluate one or more models, thus can be referred to as evaluation data. Any appropriate data analyzing technique known in the art can be employed herein. A process of time series data analysis will be described in connection with FIGS. 3, 4A, 4B, 5, and 6 hereinafter.

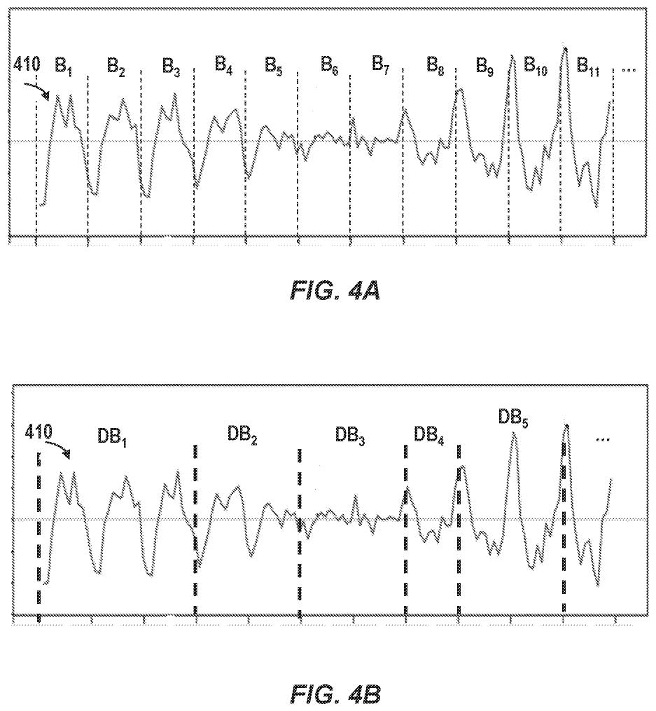

FIG. 3 depicts a flowchart 300 illustrating an exemplary process for time series data analysis according to embodiments of the present invention. FIG. 4A and FIG. 4B depicts, respectively, a graph of exemplary first time series data 410 according to embodiments of the present invention.

At block 310, the analysis module 210 may split the first time series data into a plurality of data blocks in sequence. In some embodiments, the analysis module 210 may analyze the first time series data by using any appropriate data analyzing technique, to determine an appropriate block size and split the first time series data based on the predetermined block size. As depicted in FIG. 4A, the first time series data 410 may be divided into a block sequence including the data blocks (i.e., data blocks B₁, B₂, B₃, . . . ), as indicated by dashed lines. Each data block in the block sequence may comprise a sequence of data points in time order. For example, the respective data blocks in the block sequence have an equal block size.

At block 320, the analysis module 210 may determine traits of the respective data blocks, for example, based on values of data points in the respective data blocks. In some embodiments, the trait of a data block may comprise at least one of mean, variance, autocorrelation function (ACF), partial autocorrelation function (PACF), trend, and/or the similar, of the values of data points in the data block. As an example, Table 1 illustrates some of the data blocks and corresponding exemplary traits in the first time series data 410.

TABLE 1

| Block ID | Mean | Variance | ACF | RACF | Trend |
|---|---|---|---|---|---|
| B₁ | 2.1 | 3.2 | 0.2 | 1.1 | 5.1 |
| B₂ | 2.2 | 3.3 | 0.3 | 1.2 | 4.7 |
| . . . | | | | | |
| Bₘ | 3.1 | 0.48 | 0.16 | 1.3 | 3.8 |
| Bₘ₊₁ | 3.7 | 0.5 | 0.19 | 1.3 | 1.9 |

At block 330, the analysis module 210 may cluster the respective data blocks based on the traits of the respective data blocks. As can be understood, any appropriate clustering technique known in the art can be employed herein. Table 2 illustrates some of the data blocks and corresponding traits and cluster identifications in the first time series data 410.

TABLE 2

| Block ID | Mean | Variance | ACF | RACF | Trend | Cluster ID |
|---|---|---|---|---|---|---|
| B₁ | 2.1 | 3.2 | 0.2 | 1.1 | 5.1 | C1 |
| B₂ | 2.2 | 3.3 | 0.3 | 1.2 | 4.7 | C1 |
| . . . | | | | | | |
| Bₘ | 3.1 | 0.48 | 0.16 | 1.3 | 3.8 | C3 |
| Bₘ₊₁ | 3.7 | 0.5 | 0.19 | 1.3 | 1.9 | C5 |

For example, as listed in Table 2, a first data block B₁ and a second data block B₂ may be clustered into a same cluster C1. An m^{th} data block Bₘ may be clustered into another cluster C3, and an m+1^{th} data block Bₘ₊₁ may be clustered into a different cluster C5.

At block 340, the analysis module 210 may decide whether there are data blocks adjacent to each other belonging to a same cluster.

If there are adjacent data blocks belonging to the same cluster, the analysis module 210 may merge such adjacent data blocks into a same data block at block 350. With respect to the example in Table 2, the first data block B₁ and the second data block B₂ can be merged into a new data block as they both belong to the cluster C1.

Then, the process continues at blocks 320, 330 and 340. That is, the analysis module 210 may repeat the determining, clustering, and deciding steps.

Otherwise, if no more adjacent blocks belong to a same cluster, the process ends. In such case, a plurality of data blocks with corresponding block sizes can be determined. Each data block has a set of traits different from that of the data block next to it.

As depicted in FIG. 4B, the block sequence in the first time series data 410 may be rearranged to a new block sequence comprising the data blocks with respective block sizes (i.e., data blocks DB₁, DB₂, DB₃, . . . ). For example, the data block DB₁ may include the data blocks B₁, B₂ and B₃. The data block DB₂ may include the data blocks B₄ and B₅. The data block DB₃ may include the data blocks B₆ and B₇. Other data blocks with respective block sizes can also be determined based on the above method.

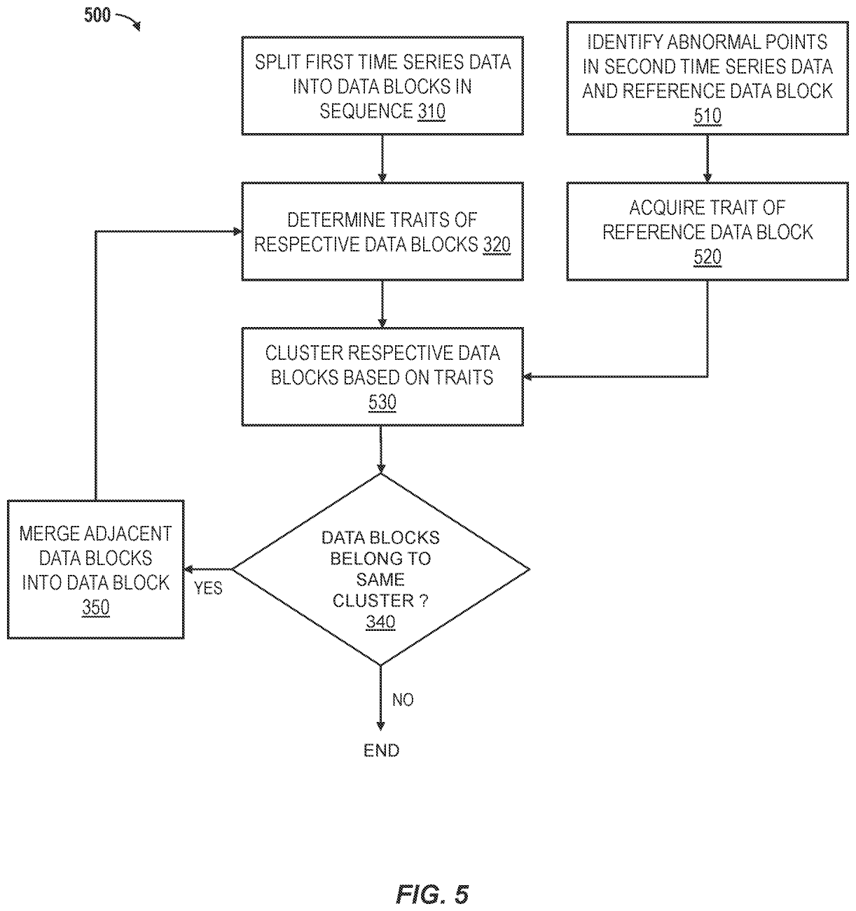

Furthermore, the analysis module 210 may perform the analysis on the first time series data based on second time series data. For example, the second time series data may be one or more sequences of data points in time order and contain at least one set of abnormal points. FIG. 5 depicts a flowchart 500 illustrating another exemplary process for time series data analysis according to embodiments of the present invention. As can be understood, the steps in blocks 310, 320, 340, 350 have been described above in connection with FIG. 3 and will not be elaborated here.

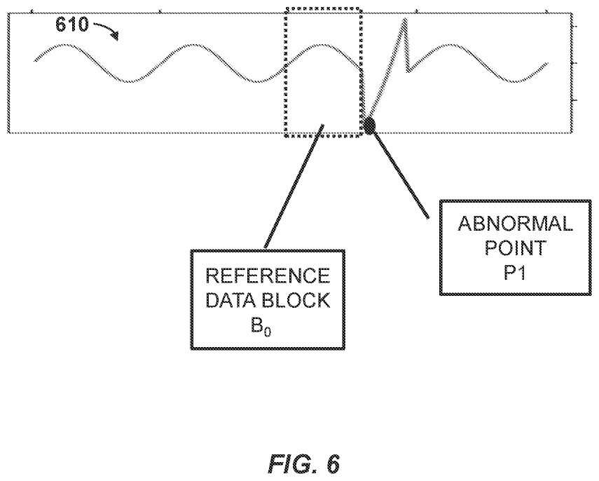

At block 510, the analysis module 210 may identify a set of abnormal points in the second time series data and a reference data block located before the set of abnormal points. For example, the second time series data may comprise historical data, training data (for training the models to be evaluated), and/or the like. FIG. 6 depicts a graph of exemplary second time series data 610 according to embodiments of the present invention.

In some embodiments, the analysis module 210 may analyze the second time series data with any appropriate data analysis technique known in the art to identify the set of abnormal points. For example, the set of abnormal points may comprise one or more abnormal points and may have a corresponding abnormal type. Thus, the analysis module 210 may identify the abnormal type of the set of abnormal points in the second time series data. For example, the abnormal type may be an extreme outlier, a variance change, a level shift, or the similar.

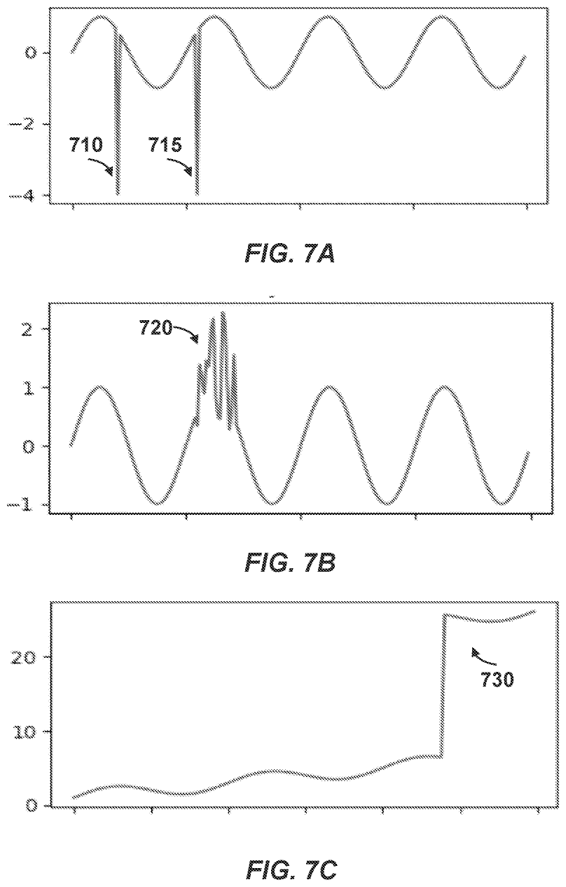

FIG. 7A, FIG. 7B, FIG. 7C show graphs of exemplary time series data with various abnormal types of abnormal points according to embodiments of the present invention. For example, FIG. 7A shows a graph of time series data with extreme outlier points 710 and 715. FIG. 7B shows a graph of time series data with variance changes 720. FIG. 7C shows a graph of time series data with a level shift 730.

With respective to the example in FIG. 6, the abnormal type of the abnormal point P1 in the second time series data 610 can be identified as an extreme outlier. Moreover, the analysis module 210 may determine a reference data block B₀ located before the set of abnormal points P1. The reference data block may have a predefined block size.

Back to FIG. 5, at block 520, the analysis module 210 may acquire a trait of the reference data block, for example, based on the values of points in the reference data block. The process then goes to block 530, which is similar to the above block 330. At block 530, the analysis module 210 may further cluster the reference data block in the second time series data with the plurality of data blocks in the first time series data based on the respective traits. Therefore, one or more target data blocks which belongs to a same cluster to the reference data block can be determined from the respective data blocks.

As can be understood, the analysis module 210 may identify a plurality of reference data blocks. Thus, corresponding target data blocks of the reference data blocks can be determined based on the above method.

Table 3 further illustrates the reference data block identified in the second time series data and corresponding traits and cluster identification.

TABLE 3

| Block ID | Mean | Variance | ACF | RACF | Trend | Cluster ID |
|---|---|---|---|---|---|---|
| B₀ | 3.2 | 0.5 | 0.17 | 1.3 | 3.7 | C3 |
| B₁ | 2.1 | 3.2 | 0.2 | 1.1 | 5.1 | C1 |
| B₂ | 2.2 | 3.3 | 0.3 | 1.2 | 4.7 | C1 |
| . . . | | | | | | |
| Bₘ | 3.1 | 0.48 | 0.16 | 1.3 | 3.8 | C3 |
| Bₘ₊₁ | 3.7 | 0.5 | 0.19 | 1.3 | 1.9 | C5 |

As listed in Table 3, the reference data block B₀ can be clustered into the cluster C3, which contains the m^{th} block Bₘ. Therefore, the m^{th} block Bₘ can be determined as the target data block.

Furthermore, the simulation module 220 in FIG. 2 may simulate, for the respective data blocks in the first time series data, one or more abnormal points based on the traits of the respective data blocks. For example, the simulation can be performed by replacing one or more data points originally in the data blocks in the first time series data with one or more new points, such that the one or more new points may form various abnormal types of abnormal points, such as an extreme outlier, a variance change, a level shift, or the similar.

In some embodiments, the abnormal type, number, value, and location of the simulated abnormal points may impact the evaluation result. For example, the simulation module 220 may determine a value, an abnormal type, a number, and/or the similar of the simulated abnormal points specific to the respective data blocks based on the corresponding traits. In a case that an average value (i.e., mean) of the points in the data block is large, abnormal points having greater values may be simulated. Otherwise, if an average value of the points in the data block is small, abnormal points having relatively small values may be simulated. Therefore, appropriate values of abnormal points can be simulated with respective to the data block.

In some further embodiments, when one or more target data blocks (corresponding to the reference data block which follows a set of abnormal points) are determined in the first time series data, a number of abnormal points simulated in a data block after the respective target data blocks may be greater than a number of abnormal points simulated in other data blocks. That is, the simulation module 220 may simulate more abnormal points in the data block after the target data block than other data blocks. As for the example in Table 3, a greater number of abnormal points can be simulated in the data block Bₘ₊₁ after the target data block Bₘ than other data blocks. Therefore, the appropriate number of abnormal points can be simulated with respective to the data block.

Moreover, the simulation module 220 may simulate, in the data block after the respective target data blocks, one or more abnormal points based on the abnormal type of the set of abnormal points after the reference block in the second time series data. As for the example in Table 3, extreme outlier abnormal points may be simulated in the data block Bₘ₊₁ after the target data block Bₘ. In such case, the appropriate type of abnormal points can be simulated with respective to the data block.

Therefore, first time series data can be updated with the simulated abnormal points. As above, the simulated abnormal points may have an appropriate abnormal type, number, values for facilitating the evaluation process as discussed below.

Back to FIG. 2, the evaluation module 230 may evaluate one or more models with the first time series data having the simulated one or more abnormal points. In some embodiments, the one or more models can be built/trained with training data. The training data may comprise one or more sequences of data points in time order and may also contain one or more set of abnormal points. Thus, the training data may also be included in the second time series data.

According to embodiments of the present invention, the time series data can be analyzed and simulated with appropriate abnormal points (for example, appropriate values, number, abnormal type, location). Such time series data with simulated abnormal points can be utilized to evaluate a plurality of models to select an optimal model that can identify the most anomalies. Thus, it may improve the anomaly detection in time series data with the selected model.

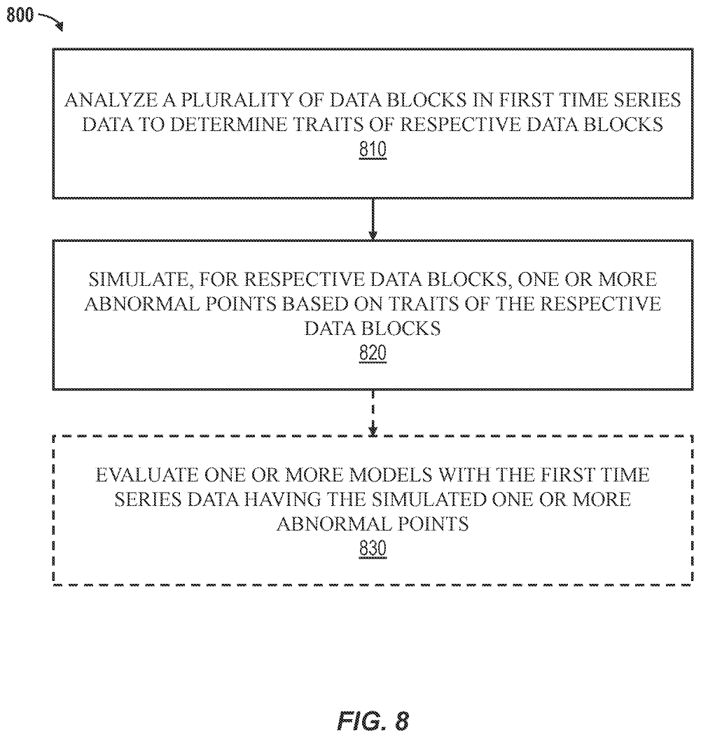

FIG. 8 depicts a schematic flowchart 800 illustrating a computer-implemented method for abnormal point simulation according to embodiments of the present invention.

It should be noted that the processing of abnormal point simulation according to embodiments of this invention could be implemented in the computing environment of FIG. 1. For example, the method can be performed by a computing device, such as the processing circuitry 120.

At block 810, the computing device analyzes a plurality of data blocks in first time series data to determine traits of respective data blocks. For example, the traits may comprise at least one of: mean, variance, autocorrelation function, partial autocorrelation function, trend, and the similar.

In some embodiments, the computing device may split the first time series data into a plurality of data blocks in sequence. The computing device may determine traits of the respective data blocks. The computing device may cluster the respective data blocks based on the traits of the respective data blocks. Then, the computing device may decide whether there are adjacent data blocks belonging to a same cluster. In response to there being adjacent data blocks belonging to a same cluster, the adjacent data blocks belonging to the same cluster may be merged into a same data block. Moreover, the determining, clustering, and deciding steps may be repeated.

In some embodiments, the computing device may further identify a set of abnormal points in second time series data and a reference data block located before the set of abnormal points. The computing device may acquire a trait of the reference data block. Then, the computing device may cluster the respective data blocks in the first time series data and the reference data block in the second time series data based on the traits of the respective data blocks and the trait of the reference data block. Therefore, one or more target data blocks belonging to a same cluster with the reference data block can be determined from the respective data blocks.

In some embodiments, the computing device may further identify an abnormal type of the set of abnormal points in the second time series data. For example, the abnormal type may comprise at least one of an extreme outlier, a variance change, a level shift, and the similar.

Therefore, various data blocks in the first time series data can be analyzed for facilitating the following simulation process.

At block 820, the computing device simulates, for the respective data blocks, one or more abnormal points based on traits of the respective data blocks.

In some embodiments, the computing device may simulate in a data block after the respective target data blocks, one or more abnormal points based on the abnormal type of the set of abnormal points in the second time series data.

In some embodiments, a number of abnormal points simulated in a data block after the respective target data blocks may be greater than that of a number of abnormal points simulated in other data blocks.

Therefore, abnormal points having appropriate values, number, type, and location can be simulated in the first time series data. In such case, the first time series data can be updated by containing the simulated abnormal points.

At block 830, the computing device evaluates one or more models with the first time series data having the simulated one or more abnormal points.

In some embodiments, the one or more models may be built with training data. The second time series data may comprise the training data and/or historical data.

Therefore, the evaluation result of the one or more models can be improved with the updated first time series data. An optimal model can be determined from the evaluation result for anomaly prediction/detection.

It can be noted that, the sequence of the blocks described in the above embodiments are merely for illustrative purposes. Any other appropriate sequences (including addition, deletion, and/or modification of at least one block) can also be implemented to realize the corresponding embodiments.

Additionally, in some embodiments of the present invention, a system for abnormal point simulation may be provided. The system may comprise one or more processors, a memory coupled to at least one of the one or more processors, and a set of computer program instructions stored in the memory. The set of computer program instructions may be executed by at least one of one or more processors to perform the above method.

In some other embodiments of the present invention, a computer program product for abnormal point simulation may be provided. The computer program product may comprise a computer readable storage medium having program instructions embodied therewith. The program instructions executable by one or more processors causes the one or more processors to perform the above method.

The present invention may be a system, a method, and/or a computer program product at any possible technical detail level of integration. The computer program product may include a computer readable storage medium (or media) having computer readable program instructions thereon for causing a processor to carry out aspects of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
analyzing, by one or more processors, a plurality of data blocks in first time series data to determine traits of respective data blocks;
simulating, by the one or more processors, for the respective data blocks, one or more abnormal points based on the traits of the respective data blocks.

2. The computer-implemented method according to claim 1, wherein analyzing the plurality of data blocks in the first time series data to determine the traits of the respective data blocks comprises:
splitting, by one or more processors, the first time series data into the plurality of data blocks in sequence;
determining, by one or more processors, the traits of the respective data blocks;
clustering, by one or more processors, the respective data blocks based on the traits of the respective data blocks;
deciding, by one or more processors, whether there are adjacent data blocks belonging to a same cluster; and
in response to there being respective adjacent data blocks belonging to a respective same cluster,
merging, by one or more processors, the respective adjacent data blocks belonging to the respective same cluster into a same data block, and
repeating, by one or more processors, the determining, the clustering, and the deciding steps.

3. The computer-implemented method according to claim 2, wherein analyzing the plurality of data blocks in the first time series data to determine the traits of the respective data blocks further comprises:
identifying, by one or more processors, a set of abnormal points in second time series data and a reference data block located before the set of abnormal points; and
acquiring, by one or more processors, a trait of the reference data block;
wherein clustering the respective data blocks based on the traits of the respective data blocks comprises:
clustering, by one or more processors, the respective data blocks and the reference data block based on the traits of the respective data blocks and the trait of the reference data block to determine one or more target data blocks from the respective data blocks that belongs to the respective same cluster to the reference data block.

4. The computer-implemented method according to claim 3, wherein identifying the set of abnormal points in the second time series data comprises:
identifying, by one or more processors, an abnormal type of the set of abnormal points in the second time series data;
wherein simulating, for the respective data blocks, the one or more abnormal points based on the traits of the respective data blocks further comprises:
simulating, by one or more processors, in a data block after the respective one or more target data blocks, the one or more abnormal points based on the abnormal type of the set of abnormal points in the second time series data.

5. The computer-implemented method according to claim 3, wherein a first number of abnormal points simulated in a data block after the respective target data blocks is greater than a second number of abnormal points simulated in other data blocks.

6. The computer-implemented method according to claim 3, further comprising:
evaluating, by one or more processors, one or more models with the first time series data having the simulated one or more abnormal points.

7. The computer-implemented method according to claim 6, wherein the one or more models are built with training data, and wherein the second time series data comprises at least one of the training data and historical data.

8. The computer-implemented method according to claim 1, wherein the traits comprise at least one of: mean, variance, autocorrelation function, partial autocorrelation function, and trend.

9. The computer-implemented method according to claim 4, wherein the abnormal type comprises at least one of: an extreme outlier, a variance change, and a level shift.

10. A system, comprising:
one or more processors;
a memory coupled to at least one of the processors; and
a set of computer program instructions stored in the memory and executed by at least one of the one or more processors in order to perform a method of:
analyzing a plurality of data blocks in first time series data to determine traits of respective data blocks;
simulating, for the respective data blocks, one or more abnormal points based on the traits of the respective data blocks.

11. The system according to claim 10, wherein analyzing the plurality of data blocks in the first time series data to determine the traits of the respective data blocks comprises:
splitting the first time series data into the plurality of data blocks in sequence;
determining the traits of the respective data blocks;
clustering the respective data blocks based on the traits of the respective data blocks;
deciding whether there are adjacent data blocks belonging to a same cluster; and
in response to there being respective adjacent data blocks belonging to a respective same cluster,
merging, by one or more processors, the adjacent data blocks belonging to the respective same cluster into a same data block, and
repeating the determining, the clustering, and the deciding steps.

12. The system according to claim 11, wherein analyzing the plurality of data blocks in the first time series data to determine the traits of the respective data blocks further comprises:
identifying a set of abnormal points in second time series data and a reference data block located before the set of abnormal points;
acquiring a trait of the reference data block;
wherein clustering the respective data blocks based on the traits of the respective data blocks comprises:
clustering the respective data blocks and the reference data block based on the traits of the respective data blocks and the trait of the reference data block to determine one or more target data blocks from the respective data blocks that belongs to the respective same cluster to the reference data block.

13. The system according to claim 12, wherein identifying the set of abnormal points in second time series data comprises:
identifying an abnormal type of the set of abnormal points in the second time series data;
wherein simulating, for the respective data blocks, the one or more abnormal points based on the traits of the respective data blocks further comprises:
simulating, in a data block after the respective one or more target data blocks, the one or more abnormal points based on the abnormal type of the set of abnormal points in the second time series data.

14. The system according to claim 12, wherein a first number of abnormal points simulated in a data block after the respective target data blocks is greater than a second number of abnormal points simulated in other data blocks.

15. The system according to claim 12, wherein the method further comprise:
evaluating one or more models with the first time series data having the simulated one or more abnormal points;
wherein the one or more models are built with training data; and
wherein the second time series data comprises at least one of the training data and historical data.

16. A computer program product, comprising a computer readable storage medium having program instructions embodied therewith, the program instructions executable by a one or more processors to cause the one or more processors to perform a method of:
analyzing a plurality of data blocks in first time series data to determine traits of respective data blocks;
simulating, for the respective data blocks, one or more abnormal points based on the traits of the respective data blocks.

17. The computer program product according to claim 16, wherein analyzing the plurality of data blocks in the first time series data to determine the traits of the respective data blocks comprises:
splitting the first time series data into the plurality of data blocks in sequence;
determining the traits of the respective data blocks;
clustering the respective data blocks based on the traits of the respective data blocks;
deciding whether there are adjacent data blocks belonging to a same cluster; and
in response to there being respective adjacent data blocks belonging to a respective same cluster,
merging, by one or more processors, the respective adjacent data blocks belonging to the respective same cluster into a same data block, and
repeating the determining, the clustering, and the deciding steps.

18. The computer program product according to claim 17, wherein analyzing the plurality of data blocks in the first time series data to determine the traits of the respective data blocks further comprises:
identifying a set of abnormal points in second time series data and a reference data block located before the set of abnormal points;
acquiring a trait of the reference data block;
wherein clustering the respective data blocks based on the traits of the respective data blocks comprises:
clustering the respective data blocks and the reference data block based on the traits of the respective data blocks and the trait of the reference data block to determine one or more target data blocks from the respective data blocks that belongs to the respective same cluster to the reference data block.

19. The computer program product according to claim 18, wherein identifying the set of abnormal points in the second time series data comprises:
identifying an abnormal type of the set of abnormal points in the second time series data;
wherein simulating, for the respective data blocks, the one or more abnormal points based on the traits of the respective data blocks further comprises:
simulating, in a data block after the respective one or more target data blocks, the one or more abnormal points based on the abnormal type of the set of abnormal points in the second time series data.

20. The computer program product according to claim 18, wherein the method further comprise:
evaluating one or more models with the first time series data having the simulated one or more abnormal points;
wherein the one or more models are built with training data; and
wherein the second time series data comprises at least one of the training data and historical data.
